(19) United States
(12) Patent Application Publication
(10) Pub. No.: US 2020/0205420 A1
(43) Pub. Date: Jul. 2, 2020

(54) BAKING OVEN

(71) Applicant: TSANN KUEN (ZHANG ZHOU) ENTERPRISE CO., LTD., Zhangzhou City (CN)

(72) Inventors: YIXIN ZHAN, Zhangzhou City (CN); DONGMEI CHEN, Zhangzhou City (CN)

(21) Appl. No.: 16/726,811

(22) Filed: Dec. 24, 2019

(30) Foreign Application Priority Data
Dec. 26, 2018 (CN) 201811603267.4

(51) Int. Cl. A21B 5/02; A47J 37/06

(52) U.S. Cl. CPC A21B 5/023; A47J 37/0611

(57) ABSTRACT

A baking oven includes a first baking tray at the rear side and a second baking tray at the front side. The first baking tray and the second baking tray can be opened or closed relative to each other. The first baking tray and the second baking tray cooperatively define a baking space used for baking ingredients and a feeding channel used for feeding the ingredients downwards into the baking space, wherein the feeding channel extends upwards and downwards to communicate the baking space with the outside. The first baking tray and the second baking tray further cooperatively define an overflow channel that communicates with the top of the baking space and is isolated from the feeding channel, to allow the air or the ingredients in the baking space to move upwards into the overflow channel.

### TECHNICAL FIELD

The present invention relates to a device for cooking food, and in particular, to a baking oven suitable for baking the batter into a waffle.

### BACKGROUND OF THE INVENTION

Referring to FIG. 1, an existing baking oven includes a seat 11 and two baking trays 12 (only one is shown in the figure due to the viewing angle) that are pivoted to the seat 11 and substantially symmetrical to each other. The two baking trays 12 can be opened or closed forwards and backwards relative to each other. The two baking trays 12 are substantially round and coupled with each other to define a baking space (not shown). Also, a feeding seat 13 is formed at the top for the ingredients such as the batter to be fed from top to bottom into the baking space.

When this existing baking oven is in use, the batter is poured from top to bottom into the feeding seat 13, and gradually fills up the baking space from the bottom of the baking space. Because the baking space is poorly breathable for the enclosed space, it is easy to form a trapped air spot at the top of the baking space. In other words, the batter often does not fill up the baking space completely, and the problem that air is wrapped in the batter and stuck at the top of the baking space will occur. As a result, the baked waffles made from the batter often have defects such as concaves or pores at the outer edges of the waffles, the appearance is less beautiful, and it is easy to be considered defective or unprofessional operation, which is needed to be improved.

### SUMMARY OF THE INVENTION

The object of the present invention is to provide a baking oven that can solve at least one of the problems mentioned in the background.

The baking oven provided by the present invention includes a first baking tray at the rear side and a second baking tray at the front side. The first and second baking trays are able to be opened or closed relative to each other. The first baking tray and the second baking tray cooperatively define a baking space for baking ingredients and a feeding channel communicated between the baking space and the outside for feeding the ingredients into the baking space. The first baking tray and the second baking tray further cooperatively define an overflow channel that communicates with the baking space and is isolated from the feeding channel, to allow air or the ingredients in the baking space to move into the overflow channel.

In an embodiment of the present invention, the feeding channel extends upwards and downwards between the outside and the baking space, and the overflow channel is communicated with the top of the baking space, to allow the air or the ingredients to move upwards and enter into the overflow channel.

In an embodiment of the present invention, the overflow channel is multiple, and the multiple overflow channels are located on opposite sides of the feeding channel.

In an embodiment of the present invention, each of the overflow channels includes an overflow hole communicated with the baking space.

In an embodiment of the present invention, each of the overflow channels further includes an overflow groove located above and communicated with the overflow hole.

In an embodiment of the present invention, the first baking tray includes a first tray plate, a first peripheral wall extending from the first tray plate towards the second baking tray and a first extension wall extending upwards from the first peripheral wall. The second baking tray includes a second tray plate, a second peripheral wall extending from the second tray plate towards the first baking tray and a second extension wall extending upwards from the second peripheral wall. The baking space is cooperatively defined between the first tray plate, the first peripheral wall, the second tray plate and the second peripheral wall. The overflow channel is cooperatively defined between the first peripheral wall and the second peripheral wall. The feeding channel is cooperatively defined between the first extension wall and the second extension wall.

In an embodiment of the present invention, the number of the overflow channel is two, and the two overflow channels each include an overflow hole cooperatively defined between the first peripheral wall and the second peripheral wall. The two overflow holes of the two overflow channels are communicated with the upper left and right corners of the baking space, respectively.

In an embodiment of the present invention, the two overflow channels each further include an overflow groove located above and communicated with the overflow hole.

In an embodiment of the present invention, each overflow groove extends from a corresponding overflow hole towards the feeding channel.

In an embodiment of the present invention, the first peripheral wall is provided with a first opening. The second peripheral wall is provided with a second opening. The overflow hole is cooperatively formed by the first opening and the second opening which are aligned with each other.

In an embodiment of the present invention, the first peripheral wall is provided with a first slot located above and communicated with the first opening. The second peripheral wall is provided with a second slot located above and communicated with the second opening. The overflow groove is cooperatively formed by the first slot and the second slot which are aligned with each other.

The baking oven provided by the present invention is used for baking ingredients into food, including:

a first baking tray;

a second baking tray matching with the first baking tray to define a baking space and a feeding channel between the first baking tray and the second baking tray, wherein the baking space is used for baking the ingredients, and the feeding channel is communicated with the baking space and used for feeding the ingredients into the baking space;

wherein two overflow channels are further defined between the first baking tray and the second baking tray, the two overflow channels are respectively located at two opposite sides of the feeding channel and isolated from the feeding channel, each of the two overflow channels is communicated with the baking space, to allow unwanted air or excessive ingredients in the baking space to move into the two overflow channels from the baking space.

In an embodiment of the present invention, the two overflow channels are symmetrical to each other with respect to the feeding channel.

In an embodiment of the present invention, the two overflow channels are communicated with the upper left and right corners of the baking space, respectively.

In an embodiment of the present invention, the first baking tray includes a first tray plate and a first peripheral wall extending from the first tray plate towards the second baking tray. The second baking tray includes a second tray plate and a second peripheral wall extending from the second tray plate towards the first baking tray. The baking space is cooperatively defined between the first tray plate, the first peripheral wall, the second tray plate and the second peripheral wall. The two overflow channels are cooperatively defined between the first peripheral wall and the second peripheral wall.

In an embodiment of the present invention, the first peripheral wall includes a first extending wall portion protruding towards the second baking tray from a periphery of the first tray plate, a first shoulder wall portion extending outwards from the first extending wall portion in parallel with the first tray plate, and a first protruding wall portion protruding towards the second baking tray from the first shoulder wall portion. The second peripheral wall abuts against the first shoulder wall portion of the first peripheral wall and is surrounded by the first protruding wall portion of the first peripheral wall.

In an embodiment of the present invention, the first protruding wall portion includes two first side wall segments, a first bottom wall segment connecting between the two first side wall segments at the bottom, two first top wall segments connecting respectively with the two first side wall segments at the top, and two first groove wall segments respectively located above and spaced apart from the two first top wall segments. The second peripheral wall includes two second side wall segments, a second bottom wall segment connecting between the two second side wall segments at the bottom, two second top wall segments connecting respectively with the two second side wall segments at the top, and two second groove wall segments respectively located above and spaced apart from the two second top wall segments. Each of the two overflow channels is cooperatively defined between a first groove wall segment, a second groove wall segment, a first top wall segment and a second top wall segment.

In an embodiment of the present invention, each of the two first top wall segments is provided with a first opening. A first slot is defined between a first groove wall segment and a corresponding first top wall segment. The first slot is communicated with the first opening. Each of the two second top wall segments is provided with a second opening. A second slot is defined between a second groove wall segment and a corresponding second top wall segment. The second slot is communicated with the second opening. Each of the two overflow channels includes an overflow hole communicated with the baking space and an overflow groove located above and communicated with the overflow hole. The overflow hole is cooperatively formed by the first opening and the second opening which are aligned with each other. The overflow groove is cooperatively formed by the first slot and the second slot which are aligned with each other.

In an embodiment of the present invention, the ingredients are batter, and the food is waffle.

The beneficial effects brought by the present invention are: the baking oven is provided with the overflow channel isolated from the feeding channel, allowing the unwanted air in the baking space to move into the overflow channel, to avoid the unwanted air to be trapped in the baking space, so that the food thus made can have a complete appearance, so as to solve the existing technical problems.

### BRIEF DESCRIPTION OF THE DRAWINGS

FIG. 1 is a side view of an existing baking oven;

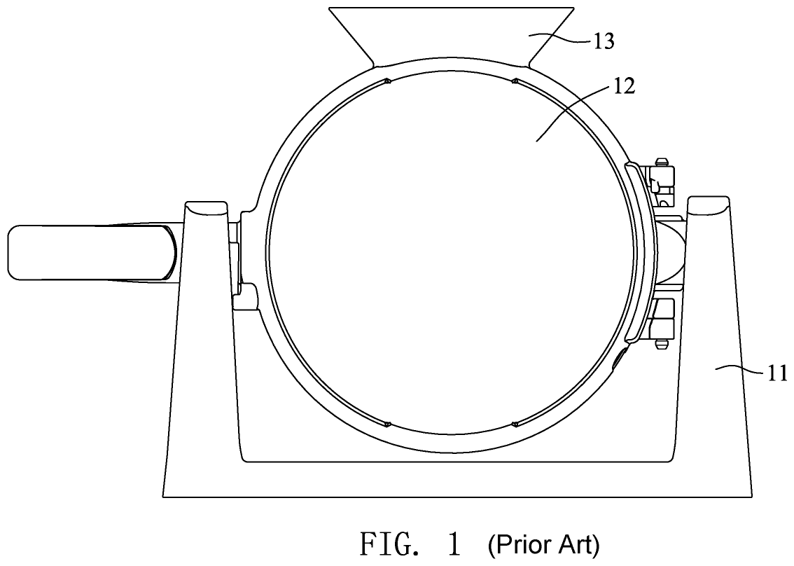

FIG. 2 is an isometric view showing an embodiment of the baking oven of the present invention;

FIG. 3 is an isometric view showing the first baking tray of the embodiment;

FIG. 4 is an isometric view with a viewing angle opposite to FIG. 3 and showing the second baking tray of the embodiment;

FIG. 5 is a cross-sectional view, sectioned along the left-to-right direction through the first protruding wall portion of the first baking tray and showing the assembly of the first baking tray and the second baking tray;

FIG. 6 is a cross-sectional view, sectioned along the line VI-VI in FIG. 2; and

FIG. 7 is a cross-sectional view, sectioned along the front-to-rear direction through the first top wall segments of the first baking tray.

### DETAILED DESCRIPTION OF PREFERRED EMBODIMENTS

The present invention will be described in detail with reference to the accompanying drawings and the embodiments. It should be noted that similar elements are represented by the same number in the following description.

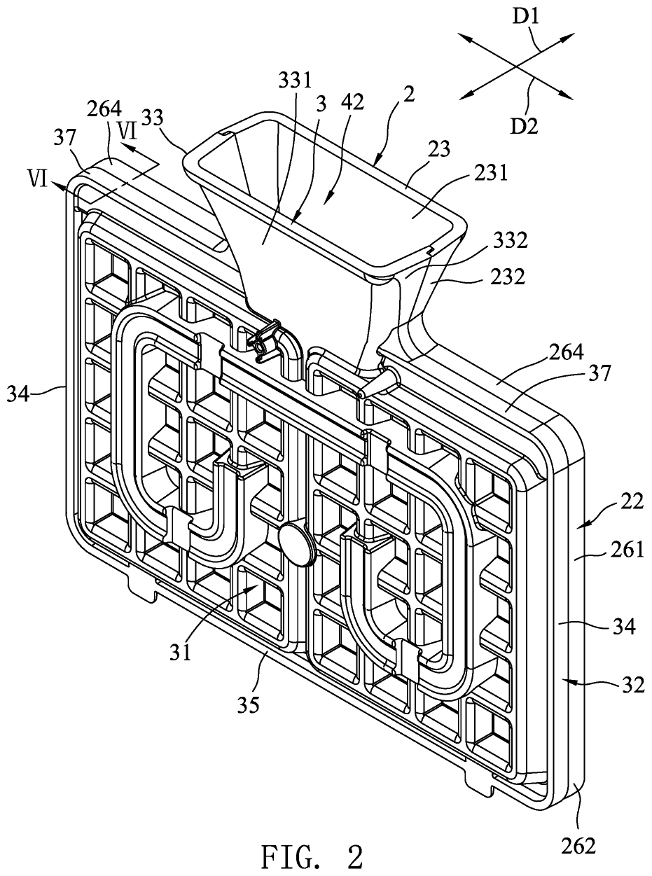

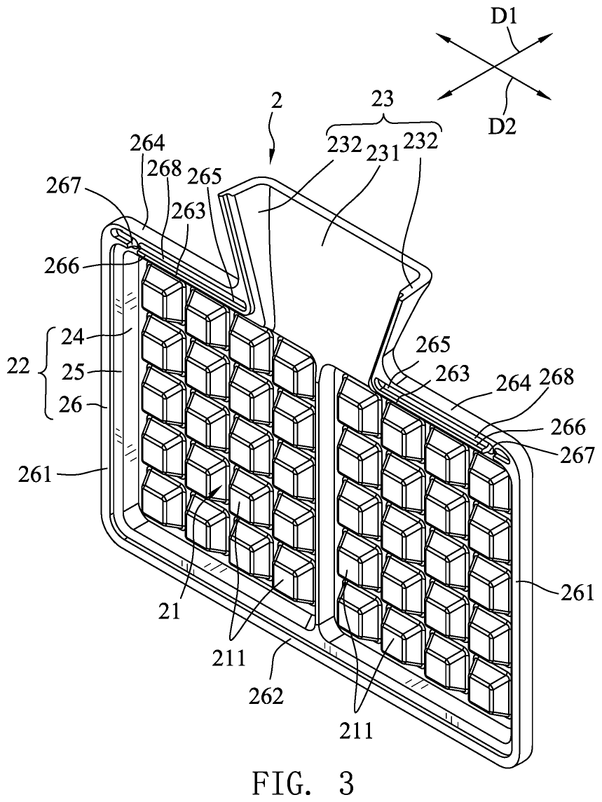

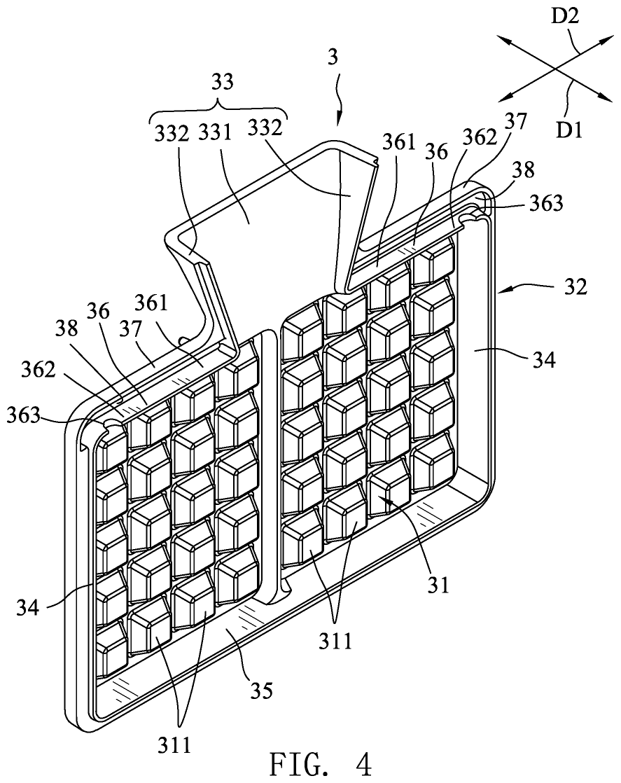

Referring to FIG. 2, FIG. 3 and FIG. 4, the baking oven provided by the present invention is suitable for baking ingredients into food. The ingredients are batter in this embodiment, and the food is waffle in this embodiment.

The baking oven includes a first baking tray 2 at the rear side and a second baking tray 3 at the front side, and the first baking tray 2 and the second baking tray 3 can be opened or closed relative to each other along a front-to-rear direction D1.

Referring to FIG. 3 to FIG. 5, the first baking tray 2 includes a substantially rectangular first tray plate 21, a first peripheral wall 22 extending from the first tray plate 21 towards the second baking tray 3, and a first extension wall 23 extending upwards from the first peripheral wall 22.

The first tray plate 21 extends lengthwise along a left-to-right direction D2. The inner surface of the first tray plate 21 is provided with a plurality of first frustums 211 protruding towards the second baking tray 3 and having a gradually shrinking size and a quadrangular pyramid shape.

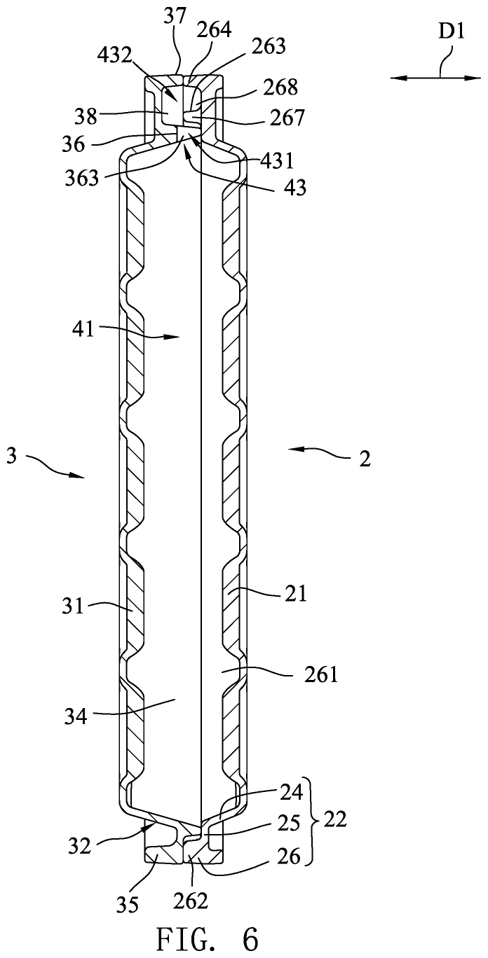

The first peripheral wall 22 includes an annular first extending wall portion 24 protruding towards the second baking tray 3 from a periphery of the first tray plate 21, an annular first shoulder wall portion 25 extending outwards from the first extending wall portion 24 in parallel with the first tray plate 21, and an annular first protruding wall portion 26 protruding towards the second baking tray 3 from the first shoulder wall portion 25 (reference can also be made to FIG. 6).

The first protruding wall portion 26 includes two first side wall segments 261 spaced apart in the left-to-right direction D2 and extending upwards and downwards, a first bottom wall segment 262 extending along the left-to-right direction D2 and connecting between the two first side wall segments 261 at the bottom, two first top wall segments 263 extending respectively from the top of the two first side wall segments 261 towards the first extension wall 23, and two first groove wall segments 264 respectively located above and spaced apart from the two first top wall segments 263.

Each first top wall segment 263 is integrally connected between a corresponding first side wall segment 261 and the first extension wall 23, and includes a first connecting end 265 connected to the first extension wall 23 and a first opening end 266 disposed opposite to the first connecting end 265 and connected to the corresponding first side wall segment 261. Each first opening end 266 is provided with a first opening 267 that is semi-circular and defined through the first top wall segment 263.

Each first groove wall segment 264 is integrally connected between a corresponding first side wall segment 261 and the first extension wall 23 along the left-to-right direction D2, and a first slot 268 extending along the left-to-right direction D2 is cooperatively defined between the first groove wall segment 264 and a corresponding first top wall segment 263. The first slot 268 is opened forwards, and communicated with the corresponding first opening 267 at the end near the corresponding first side wall segment 261.

The first extension wall 23 includes a first ladder wall portion 231 just like a trapezoid with a width that is wide at the top and narrow at the bottom, and two first lateral wall portions 232 extending towards the second baking tray 3 from the left and right sides of the first ladder wall portion 231, respectively.

The second baking tray 3 includes a substantially rectangular second tray plate 31, a second peripheral wall 32 extending from the second tray plate 31 towards the first baking tray 2, and a second extension wall 33 extending upwards from the second peripheral wall 32.

The second tray plate 31 extends lengthwise along the left-to-right direction D2. The inner surface of the second tray plate 31 is provided with a plurality of second frustums 311 protruding towards the first frustums 211 of the first baking tray 2 and having a gradually shrinking size and a quadrangular pyramid shape.

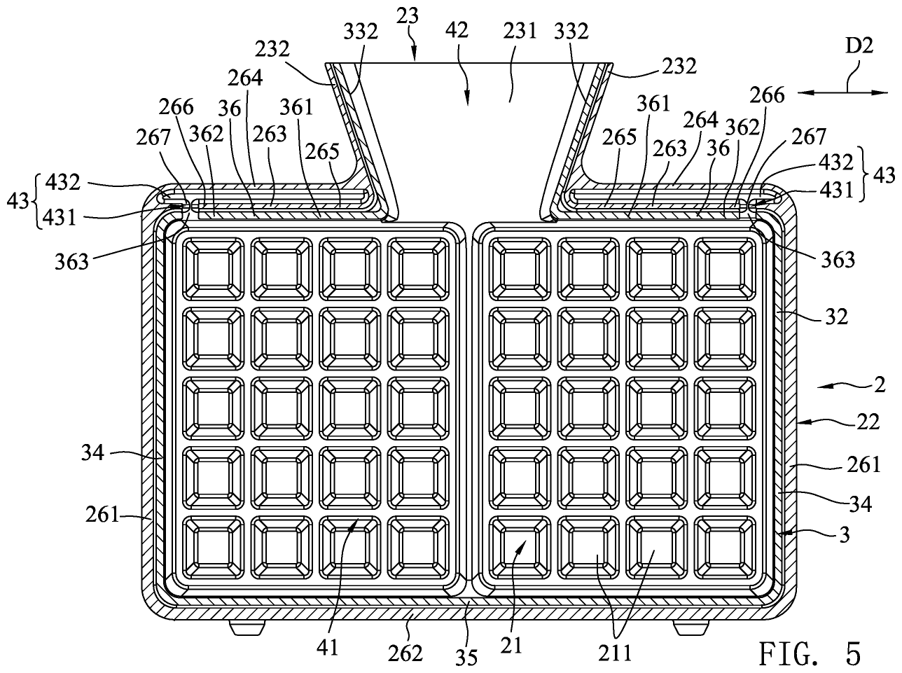

The second peripheral wall 32 has a length greater than the first peripheral wall 22 of the first baking tray 2, so that the second peripheral wall 32 can abut against the first shoulder wall portion 25 of the first peripheral wall 22 and is surrounded by the first protruding wall portion 26 of the first peripheral wall 22, as shown in FIG. 5 and FIG. 6. The second peripheral wall 32 includes two second side wall segments 34 spaced apart in the left-to-right direction D2 and extending upwards and downwards, a second bottom wall segment 35 extending along the left-to-right direction D2 and connecting between the two second side wall segments 34 at the bottom, two second top wall segments 36 extending respectively from the top of the two second side wall segments 34 towards the second extension wall 33, and two second groove wall segments 37 respectively located above and spaced apart from the two second top wall segments 36.

Each second top wall segment 36 is integrally connected between a corresponding second side wall segment 34 and the second extension wall 33, and is located under the first top wall segment 263 of the first baking tray 2 when the first baking tray 2 and the second baking tray 3 are closed to each other. Each second top wall segment 36 includes a second connecting end 361 connected to the second extension wall 33 and a second opening end 362 disposed opposite to the second connecting end 361 and connected to the corresponding second side wall segment 34. Each second opening end 362 is provided with a second opening 363 that is semi-circular and defined through the second top wall segment 36.

Each second groove wall segment 37 is integrally connected between a corresponding second side wall segment 34 and the second extension wall 33 along the left-to-right direction D2, and a second slot 38 extending along the left-to-right direction D2 is cooperatively defined between the second groove wall segment 37 and a corresponding second top wall segment 36. The second slot 38 is opened backwards, and communicated with the corresponding second opening 363 at the end near the corresponding second side wall segment 34.

The second extension wall 33 includes a second ladder wall portion 331 just like a trapezoid with a width that is wide at the top and narrow at the bottom, and two second lateral wall portions 332 extending towards the first baking tray 2 from the left and right sides of the second ladder wall portion 331, respectively.

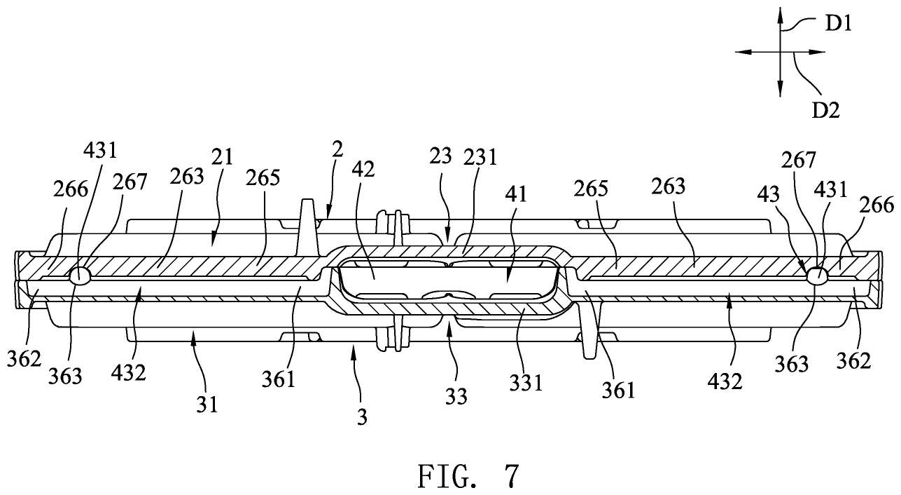

Referring to FIG. 5 to FIG. 7, the first baking tray 2 and the second baking tray 3 can be coupled with each other to a closed state for use, as shown in FIG. 2 and FIG. 5 to FIG. 7.

In the closed state, the first baking tray 2 and the second baking tray 3 cooperatively define a baking space 41 that is substantially rectangular and can be used for baking the ingredients. In more details, the baking space 41 is cooperatively defined between the first tray plate 21, the first peripheral wall 22, the second tray plate 31 and the second peripheral wall 32.

The first extension wall 23 and the second extension wall 33 cooperatively define a feeding channel 42 that extends from top to bottom and is communicated with the top of the baking space 41. The width of the feeding channel 42 in the left-to-right direction D2 is gradually reduced from top to bottom, to be shaped like a substantially flattened funnel, and the feeding channel 42 can be used for the ingredients to enter into the baking space 41 from top to bottom.

The first peripheral wall 22 of the first baking tray 2 and the second peripheral wall 32 of the second baking tray 3 are coupled together to further define two overflow channels 43 communicated with the top of the baking space 41 and isolated from the feeding channel 42, wherein the overflow channels 43 can be used for air or the ingredients to move up and enter thereinto.

Each overflow channel 43 includes an overflow hole 431 and an overflow groove 432 located above the overflow hole 431. The overflow groove 432 is communicated with the overflow hole 431. The two overflow holes 431 of the two overflow channels 43 are communicated with the upper left and right corners of the baking space 41, respectively.

Each overflow hole 431 is substantially round and cooperatively formed by the upper first opening 267 and the lower second opening 363 which are aligned with each other. Each overflow groove 432 is a long groove extending along the left-to-right direction D2, and is cooperatively formed by the first slot 268 and the second slot 38 which are aligned with each other. Each overflow groove 432 extends from a corresponding overflow hole 431 towards the feeding channel 42, but is isolated from and not communicated with the feeding channel 42.

When the baking oven is in use, the ingredients (e.g., the batter) is poured into the baking space 41 from top to bottom through the feeding channel 42, and when the ingredients gradually fill up the baking space 41 from the bottom up, the air in the top of the baking space 41 can be driven out through the feeding channel 42 and the overflow holes 431, to avoid the problem that the ingredients cannot fill up the baking space 41 entirely because the air is trapped in the top of the baking space 41.

In addition to causing the air in the baking space 41 to overflow and move into the overflow groove 432, the overflow hole 431 can also be used for the expanded excessive batter to flow into the overflow groove 432. In other embodiments of the present invention, it is also possible to omit the overflow groove 432, and the overflow hole 431 is directly communicated with the outside, which can also drive the excessive air or batter into the overflow channels 43 to be discharged out directly, to also solve the problem of food appearance defects caused by the trapped air. The baking oven of this embodiment includes the overflow groove 432 and therefore can leave the excessive air or batter inside the baking oven, thereby having the characteristics of not easily making the external environment dirty and easily cleaning.

Because the two corners of the baking space 41, i.e., the upper left and right corners, are far away from the feeding channel 42, the air in these corners is more difficult to leave through the feeding channel 42. Thus, these corners are the most likely places to form trapped air points. The overflow holes 431 are communicated with the upper left and right corners of the baking space 41, thereby having the characteristics of improving the trapped air problem optimally.

In summary, the baking oven of the present invention is provided with the overflow channel 43 isolated from the feeding channel 42, allowing the unwanted air in the baking space 41 to move into the overflow channel 43, to avoid the unwanted air to be trapped in the baking space 41, so that it can avoid the food baked from the ingredients to have defects due to the trapped air, and the food thus made can have a complete appearance, so as to solve the existing technical problems and achieve the purpose of the present invention.

The above are only the preferred embodiments of the present invention, and are not intended to limit the present invention. Any modifications, equivalents, improvements, etc., which are within the spirit of the present invention, should also be included in the scope of the present invention.

What is claimed is:

1. A baking oven, comprising a first baking tray at the rear side and a second baking tray at the front side, the first and second baking trays being able to be opened or closed relative to each other, the first baking tray and the second baking tray cooperatively defining a baking space for baking ingredients and a feeding channel communicated between the baking space and the outside for feeding the ingredients into the baking space, wherein the first baking tray and the second baking tray further cooperatively define an overflow channel that communicates with the baking space and is isolated from the feeding channel, to allow air or the ingredients in the baking space to move into the overflow channel.

2. The baking oven of claim 1, wherein the feeding channel extends upwards and downwards between the outside and the baking space, and the overflow channel is communicated with the top of the baking space, to allow the air or the ingredients to move upwards and enter into the overflow channel.

3. The baking oven of claim 2, wherein the overflow channel is multiple, and the multiple overflow channels are located on opposite sides of the feeding channel.

4. The baking oven of claim 3, wherein each of the overflow channels comprises an overflow hole communicated with the baking space.

5. The baking oven of claim 4, wherein each of the overflow channels further comprises an overflow groove located above and communicated with the overflow hole.

6. The baking oven of claim 2, wherein the first baking tray comprises a first tray plate, a first peripheral wall extending from the first tray plate towards the second baking tray and a first extension wall extending upwards from the first peripheral wall, the second baking tray comprises a second tray plate, a second peripheral wall extending from the second tray plate towards the first baking tray and a second extension wall extending upwards from the second peripheral wall, wherein the baking space is cooperatively defined between the first tray plate, the first peripheral wall, the second tray plate and the second peripheral wall, the overflow channel is cooperatively defined between the first peripheral wall and the second peripheral wall, and the feeding channel is cooperatively defined between the first extension wall and the second extension wall.

7. The baking oven of claim 6, wherein the number of the overflow channel is two, the two overflow channels each comprise an overflow hole cooperatively defined between the first peripheral wall and the second peripheral wall, the two overflow holes of the two overflow channels are communicated with the upper left and right corners of the baking space, respectively.

8. The baking oven of claim 7, wherein the two overflow channels each further comprise an overflow groove located above and communicated with the overflow hole.

9. The baking oven of claim 8, wherein each overflow groove extends from a corresponding overflow hole towards the feeding channel.

10. The baking oven of claim 8, wherein the first peripheral wall is provided with a first opening, the second peripheral wall is provided with a second opening, the overflow hole is cooperatively formed by the first opening and the second opening which are aligned with each other.

11. The baking oven of claim 10, wherein the first peripheral wall is provided with a first slot located above and communicated with the first opening, the second peripheral wall is provided with a second slot located above and communicated with the second opening, the overflow groove is cooperatively formed by the first slot and the second slot which are aligned with each other.

12. A baking oven for baking ingredients into food, comprising:
a first baking tray;
a second baking tray matching with the first baking tray to define a baking space and a feeding channel between the first baking tray and the second baking tray, wherein the baking space is used for baking the ingredients, and the feeding channel is communicated with the baking space and used for feeding the ingredients into the baking space;
wherein two overflow channels are further defined between the first baking tray and the second baking tray, the two overflow channels are respectively located at two opposite sides of the feeding channel and isolated from the feeding channel, each of the two overflow channels is communicated with the baking space, to allow unwanted air or excessive ingredients in the baking space to move into the two overflow channels from the baking space.

13. The baking oven of claim 12, wherein the two overflow channels are symmetrical to each other with respect to the feeding channel.

14. The baking oven of claim 12, wherein the two overflow channels are communicated with the upper left and right corners of the baking space, respectively.

15. The baking oven of claim 12, wherein the first baking tray comprises a first tray plate and a first peripheral wall extending from the first tray plate towards the second baking tray, the second baking tray comprises a second tray plate and a second peripheral wall extending from the second tray plate towards the first baking tray, wherein the baking space is cooperatively defined between the first tray plate, the first peripheral wall, the second tray plate and the second peripheral wall, the two overflow channels are cooperatively defined between the first peripheral wall and the second peripheral wall.

16. The baking oven of claim 15, wherein the first peripheral wall comprises a first extending wall portion protruding towards the second baking tray from a periphery of the first tray plate, a first shoulder wall portion extending outwards from the first extending wall portion in parallel with the first tray plate, and a first protruding wall portion protruding towards the second baking tray from the first shoulder wall portion, wherein the second peripheral wall abuts against the first shoulder wall portion of the first peripheral wall and is surrounded by the first protruding wall portion of the first peripheral wall.

17. The baking oven of claim 16, wherein the first protruding wall portion comprises two first side wall segments, a first bottom wall segment connecting between the two first side wall segments at the bottom, two first top wall segments connecting respectively with the two first side wall segments at the top, and two first groove wall segments respectively located above and spaced apart from the two first top wall segments, the second peripheral wall comprises two second side wall segments, a second bottom wall segment connecting between the two second side wall segments at the bottom, two second top wall segments connecting respectively with the two second side wall segments at the top, and two second groove wall segments respectively located above and spaced apart from the two second top wall segments, wherein each of the two overflow channels is cooperatively defined between a first groove wall segment, a second groove wall segment, a first top wall segment and a second top wall segment.

18. The baking oven of claim 17, wherein each of the two first top wall segments is provided with a first opening, a first slot is defined between a first groove wall segment and a corresponding first top wall segment, the first slot is communicated with the first opening, each of the two second top wall segments is provided with a second opening, a second slot is defined between a second groove wall segment and a corresponding second top wall segment, the second slot is communicated with the second opening, each of the two overflow channels comprises an overflow hole communicated with the baking space and an overflow groove located above and communicated with the overflow hole, the overflow hole is cooperatively formed by the first opening and the second opening which are aligned with each other, the overflow groove is cooperatively formed by the first slot and the second slot which are aligned with each other.

19. The baking oven of claim 12, wherein the ingredients are batter, and the food is waffle.
